(19) United States
(12) Patent Application Publication
(10) Pub. No.: US 2022/0114295 A1
(43) Pub. Date: Apr. 14, 2022

(54) METHODS, SYSTEMS, AND MEDIA FOR BUILDING CONFIGURATION OF ONE OR MORE BUILDINGS

(71) Applicant: Sidewalk Labs LLC, New York, NY (US)

(72) Inventors: Jack Amadeo, New York, NY (US); Amelia Harvey, New York, NY (US); Brian Ho, New York, NY (US); David Huang, New York, NY (US); Violet Whitney, New York, NY (US); Luda Zhao, New York, NY (US)

(21) Appl. No.: 17/497,593

(22) Filed: Oct. 8, 2021

Related U.S. Application Data
(60) Provisional application No. 63/089,684, filed on Oct. 9, 2020.

(51) Int. Cl. G06F 30/13

(52) U.S. Cl. CPC G06F 30/13; G06F 2111/04

(57) ABSTRACT

Methods, systems, and media for building configuration of one or more buildings are provided. In some embodiments, the method comprises: receiving, using a hardware processor, building constraints for a building from a computing device; receiving, using the hardware processor, an available set of geometry operations to apply to one or more floors of the building; selecting, using the hardware processor, a first geometry operation from the available set of geometry operations to apply to a first floor of the building based on the received building constraints; generating, using the hardware processor, the first floor of the building by applying the first geometry operation; selecting, using the hardware processor, a second geometry operation from the available set of geometry operations to apply to a second floor of the building based on the first floor and based on the received building constraints, wherein the second floor is vertically adjacent to the first floor; generating, using the hardware processor, the second floor of the building by applying the second geometry operation; in response to determining that additional floors are not to be added to the building based on the building constraints, generating, using the hardware processor, a configuration file representing a model of the building that stores applied geometries of at least the first floor and the second floor; and transmitting, using the hardware processor, the configuration file for generating the model of the building to the computing device.

### CROSS-REFERENCE TO RELATED APPLICATIONS

This application claims the benefit of U.S. Provisional Patent Application No. 63/089,684, filed Oct. 9, 2020, which is hereby incorporated by reference herein in its entirety.

### TECHNICAL FIELD

The disclosed subject matter relates to methods, systems, and media for building configuration of one or more buildings. More particularly, the disclosed subject matter relates to vertically stacking floor types for each building and optimally combining them into one or more building designs.

### BACKGROUND

A designer of a building may want to satisfy different objectives. For example, a designer may want to design a building that has a particular size or square footage, that has a particular number of floors, that has a particular lot size, that has a particular mix of apartment units, etc. Additionally, a designer may want the building to have a unique shape or geometry such that the building is aesthetically interesting. It can be difficult to design a building that satisfies different objectives. Moreover, the time and cost needed to coordinate all of these competing elements often means a project can only afford to develop a handful of building designs for the project team.

Current approaches for building design tend to be limited to the exterior shape of the building or have limited options as to the type of building that is being designed.

Accordingly, it is desirable to provide new methods, systems, and media for building configuration of one or more buildings.

### SUMMARY

Methods, systems, and media for building configuration of one or more buildings are provided.

In accordance with some embodiments of the disclosed subject matter, a method for building configuration is provided, the method comprising: receiving, using a hardware processor, building constraints for a building from a computing device; receiving, using the hardware processor, an available set of geometry operations to apply to one or more floors of the building; selecting, using the hardware processor, a first geometry operation from the available set of geometry operations to apply to a first floor of the building based on the received building constraints; generating, using the hardware processor, the first floor of the building by applying the first geometry operation; selecting, using the hardware processor, a second geometry operation from the available set of geometry operations to apply to a second floor of the building based on the first floor and based on the received building constraints, wherein the second floor is vertically adjacent to the first floor; generating, using the hardware processor, the second floor of the building by applying the second geometry operation; in response to determining that additional floors are not to be added to the building based on the building constraints, generating, using the hardware processor, a configuration file representing a model of the building that stores applied geometries of at least the first floor and the second floor; and transmitting, using the hardware processor, the configuration file for generating the model of the building to the computing device.

In some embodiments, the first geometry operation and the second geometry operation are different geometry operations.

In some embodiments, the first geometry operation is applied to a first portion of the first floor of the building based on the received building constraints and a third geometry operation is applied to a second portion of the first floor of the building based on the received building constraints.

In some embodiments, the second geometry operation is applied to the second floor of the building based on an outline of the first floor that preceded the second floor in the building.

In some embodiments, the second geometry operation is selected based on the first geometry operation applied to the first floor of the building.

In some embodiments, the method further comprises iteratively determining whether another floor to the building that is vertically adjacent to a currently generated floor is to be added based on the building constraints.

In some embodiments, the available set of geometry operations includes at least one of a setback building geometry operation, a courtyard building geometry operation, a bar building geometry operation, and a split building geometry operation.

In some embodiments, the method further comprises grouping floors of the building based on use type and geometry.

In some embodiments, the method further comprises determining whether at least one of the first geometry operation and second geometry operation cause the building to not meet the building constraints. In some embodiments, the method further comprises generating an alert to the computing device based on the determination that at least one of the first geometry operation and second geometry operation cause the building to not meet the building constraints. In some embodiments, the method further comprises inhibiting one of the available set of geometry operations from being selected based on the determination that at least one of the first geometry operation and second geometry operation cause the building to not meet the building constraints.

In some embodiments, the method further comprises causing an image of the model of the building including at least the first floor and the second floor to be presented on the computing device.

In some embodiments, the building constraints include building lot dimensions and the method further comprises applying one of the available set of geometry operations to subdivide a building lot having the building lot dimensions into a plurality of building lots. In some embodiments, the building is configured to be constructed on one of the plurality of building lots. In some embodiments, the first geometry operation is applied to generate the first floor of the building on each of the plurality of building lots, the second geometry operation is applied to generate the second floor of the building on each of the plurality of building lots, and the configuration file includes models of each of the buildings on each of the plurality of building lots.

In some embodiments, the first geometry operation is applied to generate a plurality of first floor configurations, the second geometry operation is applied to generate a plurality of second floor configurations, and a plurality of buildings are configured to include one of the plurality of first floor configurations and one of the plurality of second floor configurations.

In some embodiments, the method further comprises determining an available square footage for the second floor based on a geometry and a square footage of the first floor.

In some embodiments, the first floor of the building is generated by determining a layout of the first floor based on the building constraints and based on dimensions of a lower floor.

In some embodiments, each of the available set of geometry operations is associated with a floor type, the configuration file includes information for all floors contained within the building, and the information is ordered based on where each floor type is expected to be located within the building.

In accordance with some embodiments of the disclosed subject matter, a system for building configuration is provided, the system comprising a hardware processor that is configured to: receive building constraints for a building from a computing device; receive an available set of geometry operations to apply to one or more floors of the building; select a first geometry operation from the available set of geometry operations to apply to a first floor of the building based on the received building constraints; generate the first floor of the building by applying the first geometry operation; select a second geometry operation from the available set of geometry operations to apply to a second floor of the building based on the first floor and based on the received building constraints, wherein the second floor is vertically adjacent to the first floor; generate the second floor of the building by applying the second geometry operation; in response to determining that additional floors are not to be added to the building based on the building constraints, generate a configuration file representing a model of the building that stores applied geometries of at least the first floor and the second floor; and transmit the configuration file for generating the model of the building to the computing device.

In accordance with some embodiments of the disclosed subject matter, a non-transitory computer-readable medium containing computer executable instructions that, when executed by a processor, cause the processor to perform a method for building configuration is provided, the method comprising: receiving, using a hardware processor, building constraints for a building from a computing device; receiving, using the hardware processor, an available set of geometry operations to apply to one or more floors of the building; selecting, using the hardware processor, a first geometry operation from the available set of geometry operations to apply to a first floor of the building based on the received building constraints; generating, using the hardware processor, the first floor of the building by applying the first geometry operation; selecting, using the hardware processor, a second geometry operation from the available set of geometry operations to apply to a second floor of the building based on the first floor and based on the received building constraints, wherein the second floor is vertically adjacent to the first floor; generating, using the hardware processor, the second floor of the building by applying the second geometry operation; in response to determining that additional floors are not to be added to the building based on the building constraints, generating, using the hardware processor, a configuration file representing a model of the building that stores applied geometries of at least the first floor and the second floor; and transmitting, using the hardware processor, the configuration file for generating the model of the building to the computing device.

In accordance with some embodiments of the disclosed subject matter, a system for building configuration is provided, the system comprising: means for receiving building constraints for a building from a computing device; means for receiving an available set of geometry operations to apply to one or more floors of the building; means for selecting a first geometry operation from the available set of geometry operations to apply to a first floor of the building based on the received building constraints; means for generating the first floor of the building by applying the first geometry operation; means for selecting a second geometry operation from the available set of geometry operations to apply to a second floor of the building based on the first floor and based on the received building constraints, wherein the second floor is vertically adjacent to the first floor; means for generating the second floor of the building by applying the second geometry operation; means for generating a configuration file representing a model of the building that stores applied geometries of at least the first floor and the second floor in response to determining that additional floors are not to be added to the building based on the building constraints; and means for transmitting the configuration file for generating the model of the building to the computing device.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1A shows an illustrative process for generating one or more building designs having differing geometries based on building constraints in accordance with some embodiments of the disclosed subject matter.

FIG. 1B shows an illustrative process for selecting available geometry operations in a building generation application in order to generate one or more building designs having different geometries based on building constraints in accordance with some embodiments of the disclosed subject matter.

FIG. 2 shows a schematic diagram of geometry operations that can be applied to a floor of a building in accordance with some embodiments of the disclosed subject matter.

FIGS. 3A, 3B, and 3C show schematic diagrams of geometry operations that can be applied to floors of buildings in accordance with some embodiments of the disclosed subject matter.

FIG. 4 shows a schematic diagram of an illustrative system suitable for implementation of mechanisms described herein for building configuration in accordance with some embodiments of the disclosed subject matter.

FIG. 5 shows a detailed example of hardware that can be used in a server and/or a user device of FIG. 4 in accordance with some embodiments of the disclosed subject matter.

### DETAILED DESCRIPTION

In accordance with various embodiments, mechanisms (which can include methods, systems, and media) for building configuration of one or more buildings are provided.

In some embodiments, the mechanisms described herein can be used for building configuration by applying different geometry operations to individual floors and/or to sections of a building. For example, the mechanisms described herein can vertically stack building floors in order to achieve a set of target gross floor areas for the building, where one or more geometry operations can be applied to each floor or section based on the outline of the floor or section that preceded it in the stacking order of the building. In another example, the mechanisms can continue to apply varying geometry operations to each successive floor of one or more buildings while ensuring that building constraints are met.

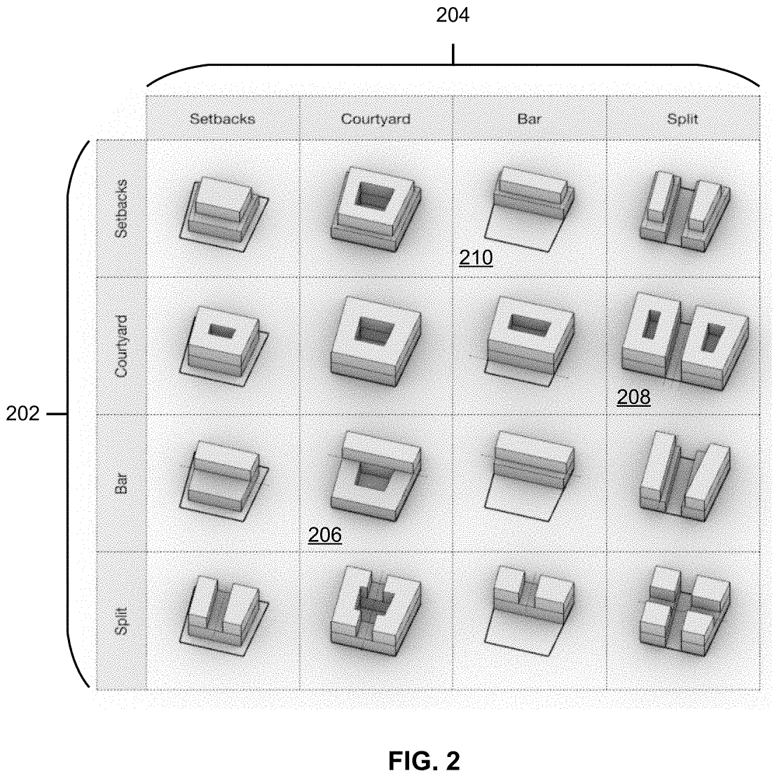

In some embodiments, potential geometry operations can be applied to a floor of a building. These potential geometry operations can include, for example, a setback building geometry operation where a floor is setback from a building facade, a courtyard building geometry operation where an inner courtyard is configured for that floor of the building, a bar building geometry operation where a fixed width bar that often contains a double loaded corridor is configured, and/or a split building geometry operation in which a floor is split into two or into a grid. For example, in some embodiments, a ground floor of a building can have a particular size and shape. Continuing further with this example, in some embodiments, a second floor can be added based on the geometry of the ground floor, where the second floor has a different geometry than the geometry of the ground floor. As a more particular example, in some embodiments, the second floor can have a geometry that includes an inner courtyard by applying a courtyard geometry operation, as shown in and described below in connection with FIG. 2. Continuing still further with this example, in some embodiments, a third floor can be added that has yet a different geometry, such as by applying a bar building geometry operation, as shown in and described below in connection with FIG. 2. In some embodiments, parameters associated with each floor (e.g., size, dimensions, locations of an inner courtyard, a distance a floor is set back or offset from a preceding lower floor, and/or any other suitable parameters) can be stored in a configuration file that includes information for all floors of a building.

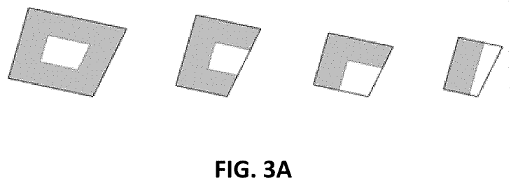

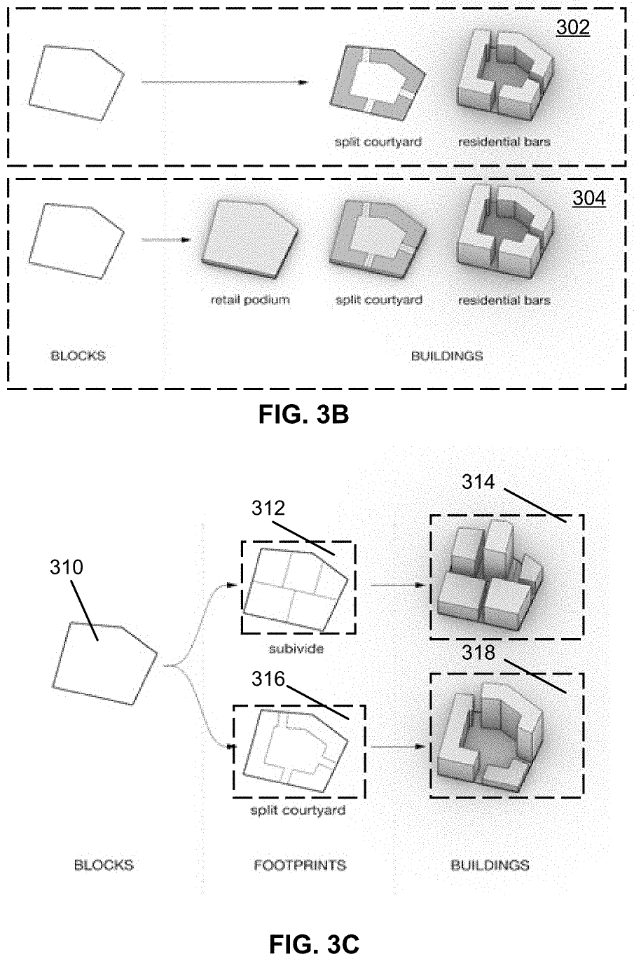

Additionally, note that, as shown in and described below in connection with FIGS. 2 and 3C, in some embodiments, geometry operations can be combined in any suitable manner. For example, in some embodiments, a geometry operation can be applied that splits a floor or section into multiple sections can be combined with a courtyard geometry operation, such that the resulting building geometry has different sections that are arranged around an inner courtyard, as shown in FIG. 3C. In another example, a geometry operation can be applied to a building lot to create a footprint upon which the subsequent floor will be dependent (e.g., a split courtyard footprint, a subdivided footprint).

It should be noted that floors of a building can be grouped into sections that include one or more floors of the same use type (e.g., commercial, residential, etc.). This combination of use type and geometry can be sometimes referred to herein as “floor type.” The floor types contained within a building can be stored in a configuration file that includes information for all floors of the building and ordered based on where each floor type is expected to be located within the building (e.g., starting from the lowest floor and proceeding upward).

It should also be noted that, in some embodiments, geometry operations can be received from any suitable source. For example, in some embodiments, geometry operations can be uploaded from one or more users of a building configuration application, where the geometry operations can be stored and/or shared for use by users of the building configuration application. In a more particular example, floor types in which a geometry operation is associated with a particular use type can be uploaded from one or more users of a building configuration application for use by other users of the building configuration application (e.g., a particular bar building geometry operation that is be associated with particular residential use type).

In some embodiments, the mechanisms described herein can apply geometry operations on a particular floor based on any suitable target constraints, such as a target floor area of the building. For example, in an instance in which the target square footage is 20,000 square feet, and in which selection of a particular geometry operation for a floor (e.g., a courtyard geometry that has an open inner portion) will cause the building to not meet the target floor area, the mechanisms described herein can present an alert and/or cause the particular geometry operation to not be available for selection. In another example, the target constraints can be continuously checked as one or more buildings are generated in a design for a set of buildings on a building lot.

Accordingly, the mechanisms described herein can automatically generate a number of different building designs having different combinations of floor geometries.

Additionally or alternatively, in some embodiments, the mechanisms described herein can provide geometry operations to a user of a building configuration application for selection, where a selected geometry operation can be applied to each floor or section of a building design.

These mechanisms can be used in any suitable application. For example, based on building constraints (e.g., building lot information, gross floor area targets, zoning information, unit mix information, etc.) and available geometry operations (e.g., bar building geometry operation, a courtyard building geometry operation, a setback building geometry operation, a split building geometry operation, etc.) for application to each floor of a building, the mechanisms can be used to automatically generate different building designs having unique combinations of geometries that meet the building constraints. In another example, based on building constraints (e.g., building lot information, gross floor area targets, zoning information, unit mix information, etc.) and available geometry operations (e.g., bar building geometry operation, a courtyard building geometry operation, a setback building geometry operation, a split building geometry operation, etc.) for application to each floor of a building, the mechanisms can be used to provide a designer using a building configuration application with allowable geometry operations for applying to a particular floor, thereby allowing the designer to construct a wider variety of building designs while still subject to any suitable building constraints, such as target floor area.

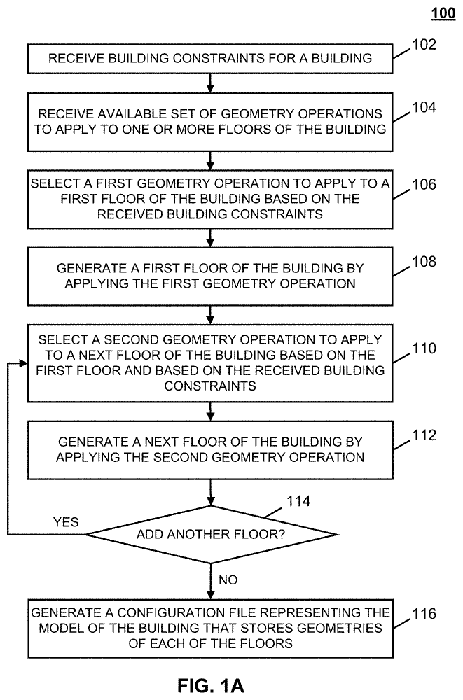

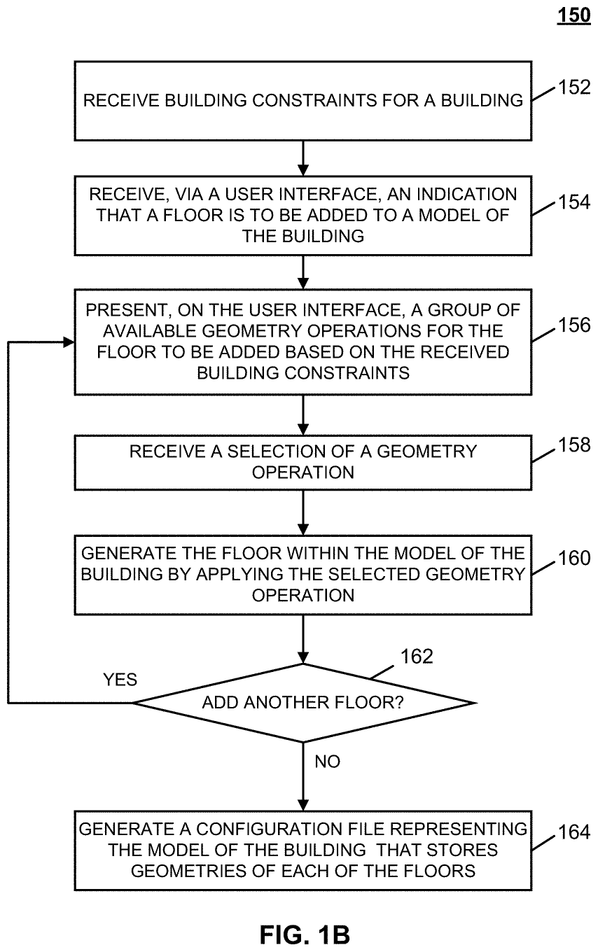

These and other features for generating building geometries are described in connection with FIGS. 1-5.

Turning to FIG. 1A, an illustrative example 100 of a process for generating one or more building designs having differing geometries based on building constraints is shown in accordance with some embodiments of the disclosed subject matter. In some embodiments, process 100 can be executed on any suitable device or any combination of devices, such as a server, a user device (e.g., a desktop computer, a laptop computer, a tablet computer, and/or any other suitable type of device). For example, in some embodiments, algorithms for generating a floor geometry can be performed by a server or by a user device. As another example, in some embodiments, user interfaces for generating building geometries can be presented on a user device.

Process 100 can begin at 102 by receiving building constraints relating to a building to be designed using process 100. In some embodiments, the building constraints can include any suitable building constraints, such as a maximum height of the building, a maximum number of floors of the building, a size or shape of the lot the building is to be located on, a target floor area of the building (e.g., a total square footage of all of the floors of the building, and/or any other suitable target floor area information), and/or any other suitable building constraints. In some embodiments, the building constraints can include constraints related to particular sections of the building, such as whether particular sections will be allocated for particular use types (e.g., residential use, commercial use, and/or any other suitable use type). Note that, in some embodiments, the building constraints can include target floor areas or target square footage for different sections of the building, such as a first target floor area for a commercial section, and a second target floor area for a residential section. Additionally, note that, in some embodiments, the building constraints can include relative locations of different sections corresponding to different use types within the building, such as that a commercial section is to be below a residential section, that a commercial section is to occupy a bottom two floors of the building, and/or any other suitable information.

At 104, process 100 can receive geometry operations that can be applied to one or more floors of a building.

Turning to FIG. 2, an example schematic diagram of geometry operations that can be applied to configure one or more floors of a building is shown in accordance with some embodiments of the disclosed subject matter.

In some embodiments, the available geometry operations can include a setback building geometry operation, a courtyard building geometry operation, a bar building geometry operation, and/or a split building geometry operation. For example, a setback geometry can correspond to a floor of the building with an offset relative to a lower floor or, in an instance in which the floor is a ground floor, an offset relative to an edge of a lot the building is located on. In another example, a courtyard geometry can correspond to a floor of the building with any suitable gap or opening in a center portion. In yet another example, a bar geometry can correspond to a floor shape that has a fixed width bar shape (e.g., that can be suitable for use as a double loaded corridor, and/or for any other suitable purpose). In a further example, a split geometry can correspond to the floor of the building being split into two or more portions.

It should also be noted that, in some embodiments, geometry operations can be received from any suitable source. For example, in some embodiments, geometry operations can be uploaded from one or more users of a building configuration application, where the geometry operations can be stored and/or shared for use by users of the building configuration application. In a more particular example, floor types in which a geometry operation is associated with a particular use type can be uploaded from one or more users of a building configuration application for use by other users of the building configuration application (e.g., a particular bar building geometry operation that is be associated with particular residential use type).

At 106, process 100 can select a first geometry operation to apply to a first floor of the building based on the received building constraints. For example, one of the available geometry operations can be selected to create a ground floor of a building on a building lot. In another example, one of the available geometry operations can be selected to create a ground floor in each of multiple buildings on a building lot that has been split into multiple lots.

It should be noted that the first geometry operation can be selected based on the received building constraints, such as the building lot having a particular size and shape. For example, process 100 can determine which of the geometry operations is available for selection based on the particular size and shape of the building lot. In a more particular example, based on the particular size and shape of the building lot and based on local laws, a split building geometry operation may be not available as the widths of the two buildings on the building lot would not comply with the local laws or other building constraints. In another more particular example, the building constraints may already include a ground floor having particular dimensions, a particular layout, and a particular use type and the first geometry operation can be selected to generate the next floor above the ground floor.

At 108, process 100 can continue to generate the first floor of the building by applying the first geometry operation to the floor based on the preceding floor. For example, the top row of the operations grid in FIG. 2 shows an example of a first floor that has been generated on a building lot having a setback geometry, a courtyard geometry, a bar geometry, and a split geometry, respectively. In a more particular example, in response to subdividing the building lot into multiple building lots, the first geometry operation can be applied to generate a first floor on each of the subdivided building lots. Note that, in some embodiments, a one or more different geometry operations can be selected for each of the subdivided lots. Note also that, in some embodiments, one or more geometry operations can be selected for a subset of the subdivided lots (e.g., generate a floor for three out of the four subdivided lots to comply with building constraints).

In some embodiments, process 100 can generate the floor in any suitable manner. For example, in some embodiments, process 100 can determine an available square footage for the floor based on a geometry and/or square footage of a lower floor. As a more particular example, in an instance in an instance in which the lower floor has a square footage of 25000 square feet and has dimensions of 500 feet by 50 feet, process 100 can determine a layout of the floor subject to the constraints of the dimensions of the lower floor. As a specific example, in an instance in which the added floor is to have a bar geometry, process 100 can determine that the floor is to have one dimension that is close to 50 feet. As another specific example, in an instance in which the added floor is to have a split geometry, process 100 can determine that the floor is to be split into two portions each having dimensions of roughly 250 feet by 50 feet. As yet another specific example, in an instance in which the added floor is to have a setback geometry, process 100 can determine a direction (e.g., that the setback is to be offset from the dimension measuring 500 feet and/or that the setback is to be offset from the dimension measuring 50 feet) in which the added floor is to be offset from the lower floor, and can determine the dimensions of the added floor based on the direction of the offset and the dimensions of the lower floor. As still another specific example, in an instance in which the added floor is to have a courtyard geometry, in some embodiments, process 100 can determine dimensions of the added floor based on the dimensions of the lower floor and dimensions of the courtyard.

It should be noted that, as shown in and described below in connection with FIGS. 2 and 3C, in some embodiments, geometry operations can be combined in any suitable manner. For example, in some embodiments, a geometry operation can be applied that splits a floor or section into multiple sections and can be combined with a courtyard building geometry operation, such that the resulting building geometry has different sections that are arranged around an inner courtyard, as shown in FIG. 3C.

Turning to FIG. 3A, FIG. 3A illustrates an example of generating a floor by applying a bar building geometry operation above a lower floor or a building lot having different dimensions. In particular, a bar building geometry operation can be applied to a floor, where the floor is constrained by the geometry and dimensions of the preceding floor. As shown, upon applying the bar building geometry operation to create a fixed width bar building, process 100 can generate the fixed width bar building to adapt to the area and outline available from the preceding floor. For example, four fixed width bar buildings are capable of being constructed given the area of the preceding floor in the leftmost design while only one fixed width bar building is capable of being constructed given the area of the preceding floor in the rightmost design.

Although process 100 of FIG. 1A is generally described as applying a geometry operation to a floor that is to be added to a model of a building, this is merely exemplary, and, in some embodiments, one or more geometry operations can be applied to multiple buildings in any suitable manner. For example, as shown in FIG. 3B, in some embodiments, a geometry operation can be applied to any floor of a building. As a more particular example, as shown in operation 302, a geometry operation can be applied to a ground floor or a building lot of a building. As a specific example, as shown in FIG. 3B, a split courtyard geometry can be applied to a ground floor or building lot of a building. Continuing further with this specific example, in some embodiments, a bar building geometry operation can be applied on top of the split courtyard geometry, as shown in operation 302. As another more particular example, as shown in operation 304, the split courtyard geometry can be applied to a second floor of a building (e.g., above a floor that is designed as a retail use area as shown in FIG. 3B), and bar buildings having a residential use type can be generated by applying a bar building geometry operation to the floor or floors above the split courtyard geometry, where the shape and dimensions of the floors having the bar building geometry are dependent upon the split courtyard geometry of the floor below it.

In some embodiments, geometry operations can be applied to a building lot to create footprints for one or multiple buildings that will be generated on that building lot.

For example, as shown in FIG. 3C, a geometry operation can be applied to building lot 310, where a subdivision geometry operation can be applied to lot 310 at 312 in which building lot 310 is divided into a subdivided footprint having any suitable number of smaller lots (e.g., five lots of varying shape and size as shown in FIG. 3C, five lots of the same area, etc.). In continuing this example, a bar building geometry operation can then be applied to one or more floors of the buildings on each lot of the subdivided footprint at 314. In another example, as also shown in FIG. 3C, a geometry operation can be applied to building lot 310, where a split courtyard geometry operation can be applied to lot 310 at 316 in which building lot 310 is divided to create a split courtyard footprint. In continuing this example, a bar building geometry operation can then be applied to one or more floors of the buildings on each of the buildings in the split courtyard footprint.

It should be noted that, in some embodiments, different geometry operations can be applied to each building. It should also be noted that, as shown in FIG. 3C, the geometry operations that are applied onto the buildings on each lot can have a different number of floors (e.g., a bar building having ten floors and a bar building having fifteen floors). It should further be noted that, in some embodiments, the number of floors of a building can be determined by received building constraints (e.g., a minimum of ten floors, a minimum gross floor area that would require at least ten floors based on the size and dimensions of the underlying building lot, etc.), a random number generator (e.g., to generate buildings of varying size and geometries while complying with building constraints), etc.

Referring back to FIG. 1A, process 100 can continue to select a second geometry operation to apply to a next floor of the building based on the first floor and based on the received building constraints at 110 and can generate a next floor of the building by applying the second floor geometry at 112. For example, a second floor can be added to a building based on the geometry of the lower floor, where the second floor has a different geometry than the geometry of the lower floor. Alternatively, a second floor can be added to a building based on the geometry of the lower floor, where the second floor has the same geometry as the lower floor but where the dimensions of the second floor are dependent upon the dimensions of the lower floor and dependent upon received building constraints (e.g., ensuring that gross floor area constraints are being met).

Turning to FIG. 2, FIG. 2 shows an example of second floor geometry operations 202 that can be applied to a first floor with a geometry that was generated by applying one of the first floor geometry operations 204. For example, geometry 206 depicts a first floor having a courtyard geometry with a second floor having a bar geometry based on the geometry of the first floor that precedes it. Note that, in some embodiments, a second floor geometry operation can be applied based on a geometry previously selected for a first floor below the second floor. For example, referring to geometry 208 in which a first floor has a split geometry, a courtyard building geometry operation for the second floor can be implemented as second levels on top of each split portion of the first floor, where each of the second floors has a courtyard. As another example, in some embodiments, a square footage area of a second floor can be based on a square footage of a first floor that is below the second floor. As a more particular example, referring to geometry 210, in which a second floor having a setback geometry is placed on top of a first floor having a bar geometry, the area of the second floor can be constrained by the area of the first floor.

At 114, process 100 can determine whether another floor should be added to the building based on the received building constraints. For example, based on the received building constraints (e.g., maximum height, maximum number of floors, particular number of floors devoted to residential space, total gross floor area, etc.), process 100 can determine whether another floor having any of the available geometries can be added above the current floor. In another example in which multiple buildings are being designed on a building lot, process 100 can determine whether another floor having a particular geometry can be added to each of the buildings (e.g., adding a next floor to one building, but not another based on building constraints).

If, at 114, process 100 determines that another floor is to be added (“yes” at 114), process 100 can loop back to 110 and can select a geometry operation to apply to the next floor or floors to be added to the building.

It should be noted that floors of a building can be grouped into sections that include one or more floors of the same use type (e.g., commercial, residential, etc.). This combination of use type and geometry can be sometimes referred to herein as “floor type.” At 116, upon determining at 114 that no additional floors are to be added to the building or buildings, the floor types contained within a building or any suitable combination of floor geometry and use type for each floor can be stored in a configuration file that includes information for all floors of the building and ordered based on where each floor type is expected to be located within the building (e.g., starting from the lowest floor and proceeding upward).

It should also be noted that the configuration file can be generated in any suitable manner. For example, in some embodiments, process 100 can generate a configuration file such that information about each floor (e.g., a geometry of the floor, size or dimensions of the floor, dimensions of offset from a lower floor, and/or any other suitable information) is presented sequentially. In some embodiments, process 100 can then save the configuration file.

Note that, in some embodiments, process 100 can present an image or diagram of the model of the completed building or buildings. For example, in some embodiments, process 100 can present a diagram of the building that allows a user of a building construction application to view a geometry of the building as a whole and/or of individual floors of the building. As a more particular example, in some embodiments, the diagram can be a three-dimensional diagram that can be manipulated to view different sides or perspectives of the building. As another more particular example, in some embodiments, different sections of the building can be selected or expanded such that a user can view geometries of different floors or sections of the building.

It should also be noted that process 100 in FIG. 1A can be repeated any suitable number of times to automatically generate different building designs having different combinations of floor geometries.

In some embodiments, a building construction application that presents the generated building design having a combination of different floor geometries can provide a user of the building construction application with an option to provide feedback on the generated building design. For example, in response to receiving an indication that the user is interested in a particular building design, the building construction application can associate the configuration file with a user account and can generate additional building designs based on the interested building design (e.g., having a similar first floor geometry but varying second floor geometries).

Accordingly, a number of different building designs having different combinations of floor geometries can be automatically generated for presentation to a user.

In accordance with some embodiments of the disclosed subject matter, geometry operations can be provided to a user of a building configuration application for selection, where a selected geometry operation can be applied to each floor or section of a building design.

Turning to FIG. 1B, similar to 102 of FIG. 1A, process 150 can begin at 152 by receiving building constraints relating to a building to be designed using process 150. In some embodiments, the building constraints can include any suitable building constraints, such as a maximum height of the building, a maximum number of floors of the building, a size or shape of the lot the building is to be located on, a target floor area of the building (e.g., a total square footage of all of the floors of the building, and/or any other suitable target floor area information), and/or any other suitable building constraints. In some embodiments, the building constraints can include constraints related to particular sections of the building, such as whether particular sections will be allocated for particular use types (e.g., residential use, commercial use, and/or any other suitable use type). Note that, in some embodiments, the building constraints can include target floor areas or target square footage for different sections of the building, such as a first target floor area for a commercial section, and a second target floor area for a residential section. Additionally, note that, in some embodiments, the building constraints can include relative locations of different sections corresponding to different use types within the building, such as that a commercial section is to be below a residential section, that a commercial section is to occupy a bottom two floors of the building, and/or any other suitable information.

At 154, process 150 can receive, via a user interface, an indication that a floor is to be added to a model of the building. In some embodiments, the indication can be received in any suitable manner. For example, in some embodiments, the indication can be received in response to determining that a user interface to create a model of a building has been launched, and that the floor to be added is therefore the first floor or ground floor of the building. As another example, in some embodiments, the indication can be received in connection with an existing model of a building. In some such embodiments, the floor to be added can be a floor that is to be a subsequent floor higher than the current highest floor of the building. Alternatively, in some embodiments, the floor to be added can be a floor in a middle portion of an existing model of a building. In some embodiments, the indication to add a floor can be received via selection of a button in the user interface (e.g., an “add floor” button).

Note that, although process 150 is generally described herein as relating to adding floors to a building layout and applying geometry operations to individual floors, in some embodiments, the techniques described herein can be used to add sections to a model of a building, where each section includes one or more floors. In some embodiments, different sections of a building can correspond to different use types, such as commercial space, residential space, and/or any other suitable type of space.

At 156, process 150 can present, on the user interface, a group of available geometry operations for the floor to be added.

Referring back to FIG. 2, an example schematic diagram of geometry operations that can be applied to configure one or more floors of a building is shown in accordance with some embodiments of the disclosed subject matter. In some embodiments, the available geometry operation can include a setback building geometry operation, a courtyard building geometry operation, a bar building geometry operation, and/or a split building geometry operation. For example, a setback geometry can correspond to a floor of the building with an offset relative to a lower floor or, in an instance in which the floor is a ground floor, an offset relative to an edge of a lot the building is located on. In another example, a courtyard geometry can correspond to a floor of the building with any suitable gap or opening in a center portion. In yet another example, a bar geometry can correspond to a floor shape that has a fixed width bar shape (e.g., that can be suitable for use as a double loaded corridor, and/or for any other suitable purpose). In a further example, a split geometry can correspond to the floor of the building being split into two or more portions.

It should also be noted that, in some embodiments, such geometry operations can be received from any suitable source. For example, in some embodiments, geometry operations can be uploaded from one or more users of a building configuration application, where the geometry operations can be stored and/or shared for use by users of the building configuration application. In a more particular example, floor types in which a geometry operation is associated with a particular use type can be uploaded from one or more users of a building configuration application for use by other users of the building configuration application (e.g., a particular bar building geometry operation that is be associated with particular residential use type).

It should further be noted that, prior to providing a group of available geometry operations for applying to a first floor of a building, a geometry operation may have been applied to a building lot (e.g., a split courtyard operation that generates a split courtyard footprint or a subdivision operation that generates a subdivided footprint as shown in FIG. 3C). The geometry operations that are available for selection may be based on the footprint of the building on which a previous geometry operation was applied.

Referring back to FIG. 1B, in some embodiments, the user interface that presents the group of available geometry operations can present the geometry operations in any suitable manner. For example, the user interface can be similar to what is shown in FIG. 2, where each square of the schematic diagram represents an available geometry operations for the floor to be added.

Note that, in some embodiments, process 150 can select available geometry operations based on any suitable building constraints. For example, in an instance in which a user has specified that the building is to have a particular target floor area and/or a particular target square footage, process 150 can determine that a particular geometry operations is not available because selection of the geometry operations would cause the building to have less than the target floor area or target square footage. As a more particular example, in an instance in which process 150 determines that adding a floor or a section of multiple floors having a courtyard geometry with an open middle portion would cause the building to have less than the target floor area or target square footage, process 150 can cause the courtyard geometry operation to be inhibited from presentation and/or presented in a manner that indicates that selection of the courtyard geometry operation would cause the building to not meet the target floor area (e.g., by graying out the courtyard geometry operation in the user interface, presenting the courtyard geometry operation with any suitable alert or message, and/or in any other suitable manner). Note that, in some embodiments, process 150 can select available geometry operations based on target floor areas for the entire building and/or based on target floor areas for different sections of the building (e.g., for a commercial section, for a residential section, and/or any other suitable section).

At 158, process 150 can receive a selection of a geometry operation. In some embodiments, process 150 can receive the selection via the user interface.

At 160, process 150 can generate the floor using the selected geometry operation. In some embodiments, process 150 can generate the floor in any suitable manner. For example, in some embodiments, process 150 can determine an available square footage for the floor based on a geometry and/or square footage of a lower floor. As a more particular example, in an instance in an instance in which the lower floor has a square footage of 25000 square feet and has dimensions of 500 feet by 50 feet, process 150 can determine a layout of the floor subject to the constraints of the dimensions of the lower floor. As a specific example, in an instance in which the added floor is to have a bar geometry, process 150 can determine that the floor is to have one dimension that is close to 50 feet. As another specific example, in an instance in which the added floor is to have a split geometry, process 150 can determine that the floor is to be split into two portions each having dimensions of roughly 250 feet by 50 feet. As yet another specific example, in an instance in which the added floor is to have a setback geometry, process 150 can determine a direction (e.g., that the setback is to be offset from the dimension measuring 500 feet and/or that the setback is to be offset from the dimension measuring 50 feet) in which the added floor is to be offset from the lower floor, and can determine the dimensions of the added floor based on the direction of the offset and the dimensions of the lower floor. As still another specific example, in an instance in which the added floor is to have a courtyard geometry, in some embodiments, process 150 can determine dimensions of the added floor based on the dimensions of the lower floor and dimensions of the courtyard.

Note that, in some embodiments, process 150 can present a schematic that shows the current model of the building after adding the floor.

At 162, process 150 can determine whether another floor is to be added. In some embodiments, process 150 can determine whether another floor is to be added in any suitable manner. For example, in some embodiments, process 150 can determine that another floor is to be added in response to determining that an “add another floor” input has been selected in the user interface described above in connection with 104. As another example, in some embodiments, process 150 can determine that another floor is not to be added in response to determining that a “done” input has been selected in the user interface described above in connection with 104. As yet another example, in some embodiments, process 150 can determine whether another floor is to be added based on building constraints received at 101. As a more particular example, in some embodiments, process 150 can determine that another floor is not to be added in response to determining that a maximum building height has been reached and/or that a maximum number of floors have been added to the building . As yet another more particular example, in some embodiments, process 150 can determine that another floor is to be added in response to determining that a target floor area of the building has not yet been reached.

If, at 162, process 150 determines that another floor is to be added (“yes” at 162), process 150 can loop back to 156 and can present a group of available geometry operations for the next floor to be added.

Conversely, if, at 162, process 150 determines that another floor is not to be added (“no” at 162), process 150 can continue to 164 and can generate a configuration file representing the model of the building that stores geometries of each of the floors. In some embodiments, process 150 can generate the configuration file in any suitable manner. For example, in some embodiments, process 150 can generate the file such that information about each floor (e.g., a geometry of the floor, size or dimensions of the floor, dimensions of offset from a lower floor, and/or any other suitable information) is presented sequentially. In some embodiments, process 150 can then save the configuration file.

Note that, in some embodiments, process 150 can present an image or diagram of the model of the completed building. For example, in some embodiments, process 150 can present a diagram of the building that allows a user to view a geometry of the building as a whole and/or of individual floors of the building. As a more particular example, in some embodiments, the diagram can be a three-dimensional diagram that can be manipulated to view different sides or perspectives of the building. As another more particular example, in some embodiments, different sections of the building can be selected or expanded such that a user can view geometries of different floors or sections of the building.

Although process 150 of FIG. 1B is generally described as applying a geometry operation to a floor that is to be added to a model of a building, this is merely exemplary, and, in some embodiments, geometry operations can be applied to buildings in any other suitable manner. For example, as shown in FIG. 3B, in some embodiments, a geometry operation can be applied to any floor of a building. As a more particular example, as shown in 302, a geometry operation can be applied to a ground floor or a building lot of a building. As a specific example, as shown in FIG. 3B, a split courtyard geometry can be applied to a building lot of a building. Continuing further with this specific example, in some embodiments, bar geometries can be applied on top of the building lot having the split courtyard geometry, as shown in 302. As another more particular example, as shown in 304, the split courtyard geometry can be applied to a second floor of a building (e.g., above a retail area as shown in FIG. 3B), and a bar building geometry operation can be applied to the floor or floors above the second floor of the building having the split courtyard geometry.

In some embodiments, geometry operations can be applied to an entire lot to subdivide the lot, as shown in FIG. 3C. As a more particular example, as shown in FIG. 3C, a lot 310 can be subdivided into different sections 312, where each section can have a different building 314. In some embodiments, each building in the different sections 312 can be constructed to have different geometries, for example, using the technique(s) described above in connection with FIG. 1B. As another more particular example, a split courtyard geometry operation 316 can be applied to lot 310 to subdivide lot 310 into sub-sections in which buildings 318 can be built with a courtyard in the center. In some embodiments, each of the buildings in buildings 318 can be constructed to have different geometries, for example, using the technique(s) described above in connection with FIG. 1B.

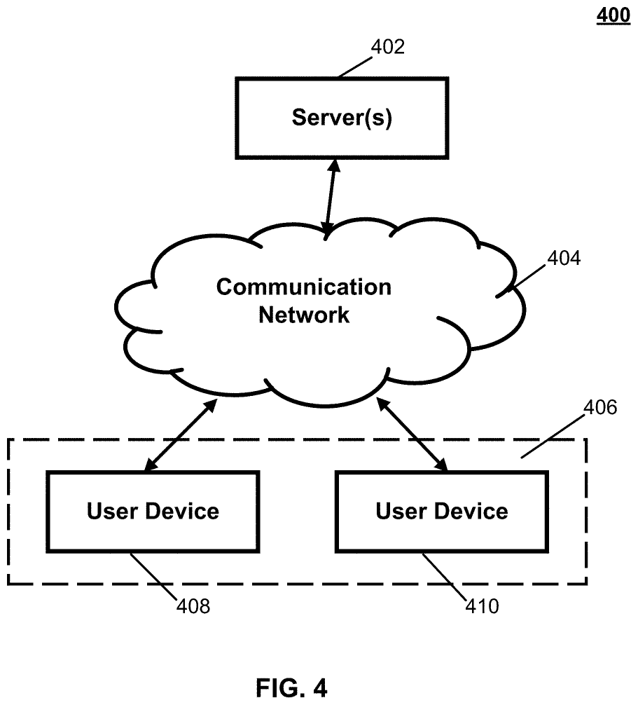

Turning to FIG. 4, an example 400 of hardware for building configuration of one or more buildings that can be used in accordance with some embodiments of the disclosed subject matter is shown. As illustrated, hardware 400 can include a server 402, a communication network 404, and/or one or more user devices 406, such as user devices 408 and 410.

In some embodiments, server 402 can be any suitable server for storing data and/or programs, executing programs (e.g., executing an algorithm to generate building geometries, as described above in connection with FIG. 1), and/or for any other suitable function(s). For example, in some embodiments, server 402 can store a program used for building configuration of one or more buildings, as described above in connection with FIGS. 1A and 1B. Note that, in instances in which server 402 executes a program or an algorithm for building construction, server 402 can receive any suitable input parameters or instructions from user device 406. For example, a user of user device 406 can provide building constraints for generating a building design. In another example, a user of user device 406 can provide and/or share one or more geometry operations for use with a building construction application executing on server 402. In some embodiments, server 402 can be omitted.

Communication network 404 can be any suitable combination of one or more wired and/or wireless networks in some embodiments. For example, communication network 404 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 406 can be connected by one or more communications links to communication network 404 that can be linked via one or more communications links to server 402. The communications links can be any communications links suitable for communicating data among user devices 406 and server 402, such as network links, dial-up links, wireless links, hard-wired links, any other suitable communications links, or any suitable combination of such links.

User devices 406 can include any one or more user devices suitable for storing data or programs, executing programs, transmitting input parameters or instructions to server 402, presenting user interfaces that present generated building designs or indicate floor geometries (e.g., as shown in and described above in connection with FIGS. 2, 3A, 3B, and 3C), and/or for performing any other suitable function(s). For example, in some embodiments, user devices 406 can include a desktop computer, a laptop computer, a mobile phone, a tablet computer, and/or any other suitable type of user device.

Although server 402 is illustrated as one device, the functions performed by server 402 can be performed using any suitable number of devices in some embodiments. For example, in some embodiments, multiple devices can be used to implement the functions performed by server 402.

Although two user devices 408 and 410 are shown in FIG. 4 to avoid over-complicating the figure, any suitable number of user devices, and/or any suitable types of user devices, can be used in some embodiments.

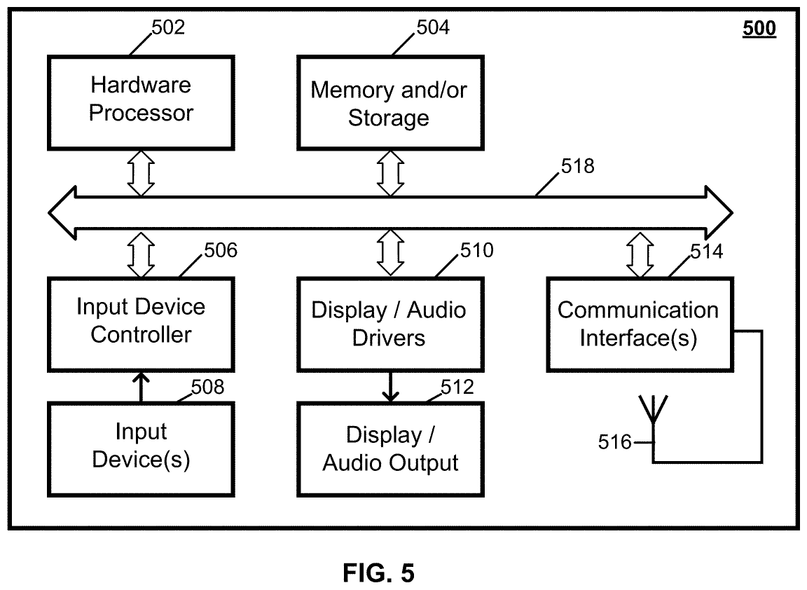

Server 402 and user devices 406 can be implemented using any suitable hardware in some embodiments. For example, in some embodiments, server 402 and user devices 406 can be implemented using any suitable general purpose computer or special purpose computer. For example, a mobile phone may be implemented using a special purpose computer. Any such general purpose computer or special purpose computer can include any suitable hardware. For example, as illustrated in example hardware 500 of FIG. 5, such hardware can include hardware processor 502, memory and/or storage 504, an input device controller 506, an input device 508, display/audio drivers 510, display and audio output circuitry 512, communication interface(s) 514, an antenna 516, and a bus 518.

Hardware processor 502 can include any suitable hardware processor, such as a microprocessor, a micro-controller, digital signal processor(s), dedicated logic, and/or any other suitable circuitry for controlling the functioning of a general purpose computer or a special purpose computer in some embodiments. In some embodiments, hardware processor 502 can be controlled by a server program stored in memory and/or storage of a server, such as server 402. In some embodiments, hardware processor 502 can be controlled by a computer program stored in memory and/or storage 504 of user device 406.

Memory and/or storage 504 can be any suitable memory and/or storage for storing programs, data, and/or any other suitable information in some embodiments. For example, memory and/or storage 504 can include random access memory, read-only memory, flash memory, hard disk storage, optical media, and/or any other suitable memory.

Input device controller 506 can be any suitable circuitry for controlling and receiving input from one or more input devices 508 in some embodiments. For example, input device controller 506 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 510 can be any suitable circuitry for controlling and driving output to one or more display/audio output devices 512 in some embodiments. For example, display/audio drivers 510 can be circuitry for driving a touchscreen, a flat-panel display, a cathode ray tube display, a projector, a speaker or speakers, and/or any other suitable display and/or presentation devices.

Communication interface(s) 514 can be any suitable circuitry for interfacing with one or more communication networks (e.g., computer network 404). For example, interface(s) 514 can include network interface card circuitry, wireless communication circuitry, and/or any other suitable type of communication network circuitry.

Antenna 516 can be any suitable one or more antennas for wirelessly communicating with a communication network (e.g., communication network 404) in some embodiments. In some embodiments, antenna 516 can be omitted.

Bus 518 can be any suitable mechanism for communicating between two or more components 502, 504, 506, 510, and 514 in some embodiments.

Any other suitable components can be included in hardware 500 in accordance with some embodiments.

In some embodiments, at least some of the above described blocks of the processes of FIG. 1 can be executed or performed in any order or sequence not limited to the order and sequence shown in and described in connection with the figure. Also, some of the above blocks of FIG. 1 can be executed or performed substantially simultaneously where appropriate or in parallel to reduce latency and processing times. Additionally or alternatively, some of the above described blocks of the process of FIG. 1 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for building configuration of one or more buildings are provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for building configuration, the method comprising:
receiving, using a hardware processor, building constraints for a building from a computing device;
receiving, using the hardware processor, an available set of geometry operations to apply to one or more floors of the building;
selecting, using the hardware processor, a first geometry operation from the available set of geometry operations to apply to a first floor of the building based on the received building constraints;
generating, using the hardware processor, the first floor of the building by applying the first geometry operation;
selecting, using the hardware processor, a second geometry operation from the available set of geometry operations to apply to a second floor of the building based on the first floor and based on the received building constraints, wherein the second floor is vertically adjacent to the first floor;
generating, using the hardware processor, the second floor of the building by applying the second geometry operation;
in response to determining that additional floors are not to be added to the building based on the building constraints, generating, using the hardware processor, a configuration file representing a model of the building that stores applied geometries of at least the first floor and the second floor; and
transmitting, using the hardware processor, the configuration file for generating the model of the building to the computing device.

2. The method of claim 1, wherein the first geometry operation and the second geometry operation are different geometry operations.

3. The method of claim 1, wherein the first geometry operation is applied to a first portion of the first floor of the building based on the received building constraints and a third geometry operation is applied to a second portion of the first floor of the building based on the received building constraints.

4. The method of claim 1, wherein the second geometry operation is applied to the second floor of the building based on an outline of the first floor that preceded the second floor in the building.

5. The method of claim 1, wherein the second geometry operation is selected based on the first geometry operation applied to the first floor of the building.

6. The method of claim 1, further comprising iteratively determining whether another floor to the building that is vertically adjacent to a currently generated floor is to be added based on the building constraints.

7. The method of claim 1, wherein the available set of geometry operations includes at least one of a setback building geometry operation, a courtyard building geometry operation, a bar building geometry operation, and a split building geometry operation.

8. The method of claim 1, further comprising grouping floors of the building based on use type and geometry.

9. The method of claim 1, further comprising determining whether at least one of the first geometry operation and second geometry operation cause the building to not meet the building constraints.

10. The method of claim 9, further comprising generating an alert to the computing device based on the determination that at least one of the first geometry operation and second geometry operation cause the building to not meet the building constraints.

11. The method of claim 9, further comprising inhibiting one of the available set of geometry operations from being selected based on the determination that at least one of the first geometry operation and second geometry operation cause the building to not meet the building constraints.

12. The method of claim 1, further comprising causing an image of the model of the building including at least the first floor and the second floor to be presented on the computing device.

13. The method of claim 1, wherein the building constraints include building lot dimensions and wherein the method further comprises applying one of the available set of geometry operations to subdivide a building lot having the building lot dimensions into a plurality of building lots.

14. The method of claim 13, wherein the building is configured to be constructed on one of the plurality of building lots.

15. The method of claim 13, wherein the first geometry operation is applied to generate the first floor of the building on each of the plurality of building lots, wherein the second geometry operation is applied to generate the second floor of the building on each of the plurality of building lots, and wherein the configuration file includes models of each of the buildings on each of the plurality of building lots.

16. The method of claim 1, wherein the first geometry operation is applied to generate a plurality of first floor configurations, wherein the second geometry operation is applied to generate a plurality of second floor configurations, and wherein a plurality of buildings are configured to include one of the plurality of first floor configurations and one of the plurality of second floor configurations.

17. The method of claim 1, further comprising determining an available square footage for the second floor based on a geometry and a square footage of the first floor.

18. The method of claim 1, wherein the first floor of the building is generated by determining a layout of the first floor based on the building constraints and based on dimensions of a lower floor.

19. The method of claim 1, wherein each of the available set of geometry operations is associated with a floor type, wherein the configuration file includes information for all floors contained within the building, and wherein the information is ordered based on where each floor type is expected to be located within the building.

20. A system for building configuration, the system comprising:
a hardware processor that is configured to:
receive building constraints for a building from a computing device;
receive an available set of geometry operations to apply to one or more floors of the building;
select a first geometry operation from the available set of geometry operations to apply to a first floor of the building based on the received building constraints;
generate the first floor of the building by applying the first geometry operation;
select a second geometry operation from the available set of geometry operations to apply to a second floor of the building based on the first floor and based on the received building constraints, wherein the second floor is vertically adjacent to the first floor;
generate the second floor of the building by applying the second geometry operation;
in response to determining that additional floors are not to be added to the building based on the building constraints, generate a configuration file representing a model of the building that stores applied geometries of at least the first floor and the second floor; and
transmit the configuration file for generating the model of the building to the computing device.

21. A non-transitory computer-readable medium containing computer executable instructions that, when executed by a processor, cause the processor to perform a method for building configuration, the method comprising:
receiving, using a hardware processor, building constraints for a building from a computing device;
receiving, using the hardware processor, an available set of geometry operations to apply to one or more floors of the building;
selecting, using the hardware processor, a first geometry operation from the available set of geometry operations to apply to a first floor of the building based on the received building constraints;
generating, using the hardware processor, the first floor of the building by applying the first geometry operation;
selecting, using the hardware processor, a second geometry operation from the available set of geometry operations to apply to a second floor of the building based on the first floor and based on the received building constraints, wherein the second floor is vertically adjacent to the first floor;
generating, using the hardware processor, the second floor of the building by applying the second geometry operation;
in response to determining that additional floors are not to be added to the building based on the building constraints, generating, using the hardware processor, a configuration file representing a model of the building that stores applied geometries of at least the first floor and the second floor; and
transmitting, using the hardware processor, the configuration file for generating the model of the building to the computing device.
